(19) United States
(12) Patent Application Publication
(10) Pub. No.: US 2004/0212757 A1
(43) Pub. Date: Oct. 28, 2004

(54) Liquid crystal display apparatus

(76) Inventors: Jeong-Hwan Lee, Gyeonggi-do (KR); Jong-Dae Park, Seoul (KR); Kyu-Seok Kim, Yongin-si (KR); Sang-Duk Lee, Yongin-si (KR)

Correspondence Address: CANTOR COLBURN, LLP, 55 GRIFFIN ROAD SOUTH, BLOOMFIELD, CT, 06002

(21) Appl. No.: 10/491,298

(22) PCT Filed: Jul. 24, 2002
(86) PCT No.: PCT/KR02/01384

(30) Foreign Application Priority Data
Dec. 27, 2001 (KR) 2001/85956
Apr. 17, 2002 (KR) 2002/20902

(51) Int. Cl. G02F 1/1335

(52) U.S. Cl. 349/64

(57) ABSTRACT

Disclosed is a liquid crystal display apparatus (600) having enhanced axial brightness as well as embodying a thin and lightweight LCD. A first light (L1) generated from a light source (120) is incident to a light guiding plate (200). A path of the first light is changed by the light guiding plate (200), and a third light (L3) exits toward a reflecting plate (300). Then, the third light (L3) is reflected on the reflecting plate (300) to be changed into a second light (L2) with enhanced axial brightness. The third light (L3) is converged to be the second light (L2) with enhanced axial brightness by the reflecting late (300) with a surface structure having a triangular prism shape. Thus, the liquid crystal display apparatus is capable of enhancing the axial brightness as well as minimizing the overall dimension and weight.

### TECHNICAL FIELD

The present invention relates to a liquid crystal display apparatus, and more particularly to a liquid crystal display (LCD) apparatus for enhancing axial brightness as well as embodying a thin and lightweight LCD.

### BACKGROUND ART

In recent years, information-processing devices have been rapidly developed to have various forms, functions and faster information processing speed. Such an information-processing device requires a display device that displays the processed information.

A CRT (Cathode Ray Tube)-type display device typically has been employed as the display apparatus, but recently a liquid crystal display apparatus lighter and smaller than the CRT-type display device has been developed so as to be most available as computer monitors, home wall mounted TV sets, and display apparatus for other information processing devices.

Generally, a liquid crystal display apparatus applies voltage to a liquid crystal with a specific molecular arrangement so as to convert the specific molecular arrangement into another molecular arrangement. Then, the liquid crystal display apparatus converts the changes of the optical properties, for example birefringence, optical rotary power, dichroism and optical scattering characteristics of liquid crystal cells that emit a light according to the molecular arrangement, into the changes of the vision, and uses the modulation of the light of the liquid crystal cells in order to display information.

Since the liquid crystal display apparatus is a passive light element incapable of emitting light by itself, the liquid crystal display apparatus displays images by means of a backlight assembly attached at the rear of the liquid crystal panel.

Nowadays, several structures to achieve a slim and lightweight LCD have been developed in order to have the leading edge of the competitiveness. Specially, a lightweight LCD is treated as a more important factor considering that the LCD is mainly used in a portable computer, etc.

In such a liquid crystal display apparatus, the dimension and light efficiency, etc. of the liquid crystal display apparatus vary in accordance with the structure of the backlight assembly, and the structure of the backlight assembly affects the overall mechanical/optical characteristics of the liquid crystal display apparatus. Accordingly, the role and function of the backlight assembly have been gradually important tasks.

FIG. 1 is an exploded perspective view showing a conventional liquid crystal display apparatus, and FIG. 2 is a cross-sectional view showing the liquid crystal display apparatus as shown in FIG. 1.

Referring to FIGS. 1 and 2, a liquid crystal display apparatus 50 includes a backlight assembly 30 for generating light and a liquid crystal display panel 40 for receiving the light to display images.

The backlight assembly 30 includes a light source section 10 provided with a lamp 12 for generating a first light and a lamp cover 14 that covers one side of the lamp 12, and a light guiding plate 20 for guiding the first light toward the liquid crystal display panel 40. A cold cathode tube is chiefly employed as a lamp 12, and the first light generated from the lamp 12 is incident to the lateral surface of the light guiding plate 20. A light reflecting member is formed on the inner surface of the lamp cover 14, and the lamp cover 14 reflects the first light toward the light guiding plate 20 side, thereby enhancing the utilization efficiency of the first light.

The light guiding plate 20 allows the first light from the lamp 12 to proceed toward the liquid crystal display panel 40 that is installed on the upper portion of the light guiding plate 20. For performing this operation, various patterns (not shown), such as fine dot patterns, are printed on the bottom surface of the light guiding plate 20. The various patterns divert the direction of the first light toward the liquid crystal display panel 40.

Meantime, a reflecting plate 22 is installed under the light guiding plate 20. A diffusion sheet 32, a first prism sheet 34, a second prism sheet 36 and a protective sheet 38 are sequentially stacked on the light guiding plate 20.

The reflecting plate 22 reflects the second light that leaks without being reflected by the printed patterns of the light guiding plate 20 toward the light guiding plate 20, accordingly the reflecting plate 22 prevent loss of the third light that is incident to the liquid crystal display panel 40.

The diffusion sheet 32 disperses the third light incident from the light guiding plate 20 so as to prevent a partial gathering phenomenon of a fourth light emitted from the diffusion sheet 32.

A plurality of triangle prisms is formed on the upper surface of the first and second prism sheets 34 and 36, respectively. The first and second prism sheets 34 and 36 enhance the axial brightness by making the angular field of the fourth light diffused by the diffusion sheet 32 narrow. In other words, the first and second sheets 34 and 36 converge the fourth light incident from the diffusion sheet 32 to the first and second directions D1 and D2 which are orthogonal each other on a plane in parallel with the display plane of the liquid of the liquid crystal panel 40, thereby emitting a fifth light having an enhanced axial brightness.

The protective sheet 38 protects the surface of the second prism sheet 36, and prevents the moire and rainbow phenomena induced by the first and second prism sheets 34 and 36.

The fifth light, which is generated from the lamp 12 and is passed through the plurality of optical sheets as described above, is displayed as image by means of the liquid crystal display panel 40.

The conventional liquid crystal display apparatus 50 as above includes the plurality of sheets 32, 34, 36 and 38 that diffuse and converge the light guided by the light guiding plate 20 so as to enhance the brightness in the front directions. Although such a structure can enhance the display characteristic of the liquid crystal display apparatus, it requires the plurality of sheets 32, 34, 36 and 38. Therefore, the assembling method of the liquid crystal display apparatus 50 becomes complicated, and overall dimension and weight of the liquid crystal display apparatus 50 increase.

### DISCLOSURE OF THE INVENTION

Therefore, an object of the present invention is to provide a liquid crystal display apparatus enhancing axial brightness as well as embodying a thin and lightweight LCD.

To achieve the above object of the present invention, there is provided liquid crystal display apparatus comprising i) a light source for generating a first light; ii) a light guiding plate including an incident plane for receiving the first light, a first exit surface for guiding the first light transmitted through the incident plane so as to output a third light, and a second exit surface, being opposite to the first exit surface, for outputting a second light incident via the first exit surface; iii) a reflecting plate, being placed below a lower side of the first exit surface of the light guiding plate and having a plurality of protruding portions protruded from a reflecting plane which is opposite to the first exit surface, for reflecting the third light and providing the second light having an enhanced axial brightness to the light guiding plate; iv) a liquid crystal display panel for receiving the second light from the light guiding plate to display images.

Here, the reflecting plate has i) a supporting layer; ii) a converging layer having a plurality of protruding portions, each of the protruding portions being protruded from a surface of the supporting layer so as to have a prism shape, and the protruding portions being formed repeatedly on the surface of the supporting layer from a first end portion of the supporting layer to a second end portion of the supporting layer, the second end portion being oppose to the first end portion; iii) a reflecting layer covering a whole surface of the converging layer and being formed so as to have a predetermined thickness consistent on the converging layer.

To achieve the above and other objects of the present invention, a liquid crystal display apparatus includes liquid crystal display apparatus comprising i) a light source for generating a first light; ii) a light guiding plate including an incident plane for receiving the first light, a first exit surface having a plurality of light guide patterns for guiding the first light transmitted through the incident plane so as to output a third light, and a second exit surface, being opposite to the first exit surface, for outputting a second light incident via the first exit surface; iii) a reflecting plate, being placed below a lower side of the first exit surface of the light guiding plate and having a plurality of protruding portions protruded from a reflecting plane which is opposite to the first exit surface, for reflecting the third light and providing the second light having an enhanced axial brightness to the light guiding plate; iv) a liquid crystal display panel for receiving the second light from the light guiding plate to display images.

At this time, the light guide patterns protrude toward the reflecting plate in a dot shape having a predetermined height, for guiding the first light toward the reflecting plate side.

According to the present invention, the surface of the reflecting plate has a shape of triangular prisms, so that the third light, which is guided toward the reflecting plate by means of the light guiding plate, is converged and a second light having enhanced axial brightness is reflected toward the liquid crystal display panel side. Therefore, the liquid crystal display apparatus is able to enhance the axial brightness by the reflecting plate as well as to minimize the overall dimension and weight.

According to the present invention, a first light generated from the light source is incident toward the light guiding plate. Then, the path of the first light is changed, and a third light is exited from the light guiding plate and is guided toward the light guiding plate. Thereafter, the third light is converged by the reflecting plate with the surface structure having a shape of triangular prisms, and the reflected third light i.e., a second light has enhanced axial brightness. The liquid crystal display panel is supplied with the second light having enhanced axial brightness so as to display images.

As a result, the reflecting plate having a shape of prisms can enhance the axial brightness of the liquid crystal display apparatus. Also, the reflecting plate serves as the conventional prism sheet so as to reduce the number of sheets required in the liquid crystal display apparatus, therefore it can minimize the overall dimension and weight of the liquid crystal display apparatus.

### BRIEF DESCRIPTION OF DRAWINGS

The above objects and other advantages of the present invention will become more apparent by describing in detail preferred embodiments thereof with reference to the attached drawings, in which:

FIG. 1 is a perspective view showing a conventional liquid crystal display apparatus;

FIG. 2 is a cross-sectional view showing the liquid crystal display apparatus as shown in FIG. 1;

FIG. 3 is an exploded perspective view showing a liquid crystal display apparatus according to one preferred embodiment of the present invention;

FIG. 4 is a cross-sectional view showing the liquid crystal display apparatus of FIG. 3;

FIGS. 5A to 5C are cross-sectional views showing a method of manufacturing a reflecting plate as shown in FIG. 4 according to a first preferred embodiment of the present invention;

FIG. 6 is a perspective view showing a structure of the reflecting plate shown in FIG. 5C;

FIGS. 7 and 8 show a structure of the reflecting plate according to a second preferred embodiment of the present invention;

FIGS. 9 shows a structure of the reflecting plate according to a third preferred embodiment of the present invention;

FIG. 10 shows a structure of the reflecting plate according to a fourth preferred embodiment of the present invention;

FIGS. 11a and 11b are cross-sectional views showing the method for manufacturing the reflecting plate according to a fifth preferred embodiment of the present invention;

FIGS. 12A to 14C are perspective views for explaining the structure of the reflecting plate;

FIG. 15 is a cross-sectional view showing a light guiding plate of FIG. 3;

FIG. 16 is a magnified view showing a portion A designated in FIG. 15;

FIG. 17 is a plane view showing the rear plane of the light guiding plate of FIG. 15;

FIG. 18 is an magnified view showing partly enlarged B and C portions of FIG. 17; and

FIG. 19 is a perspective view showing the optical path in a backlight assembly according to one preferred embodiment of the present invention.

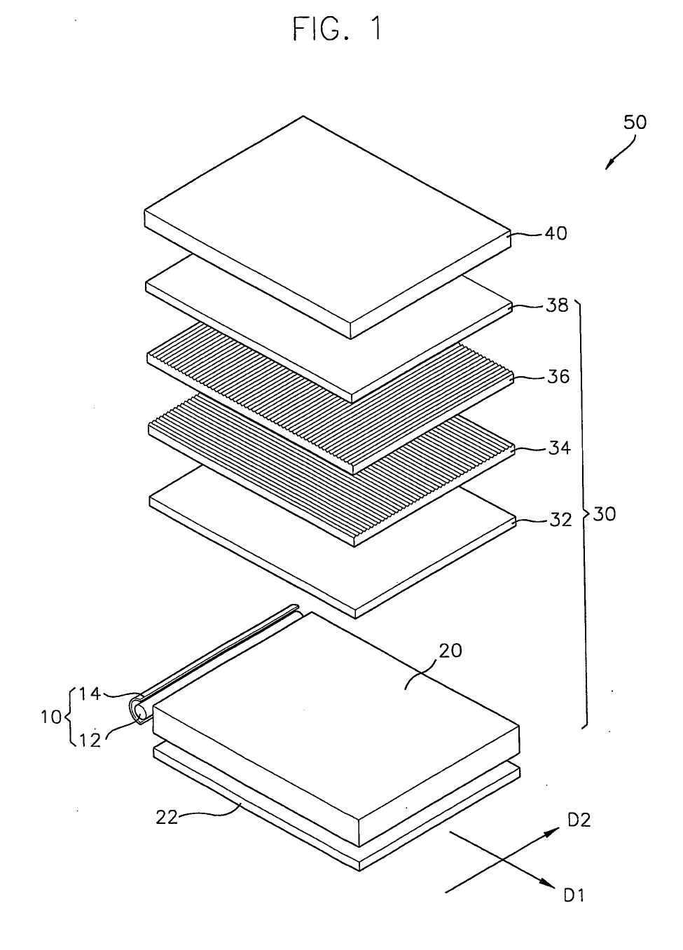

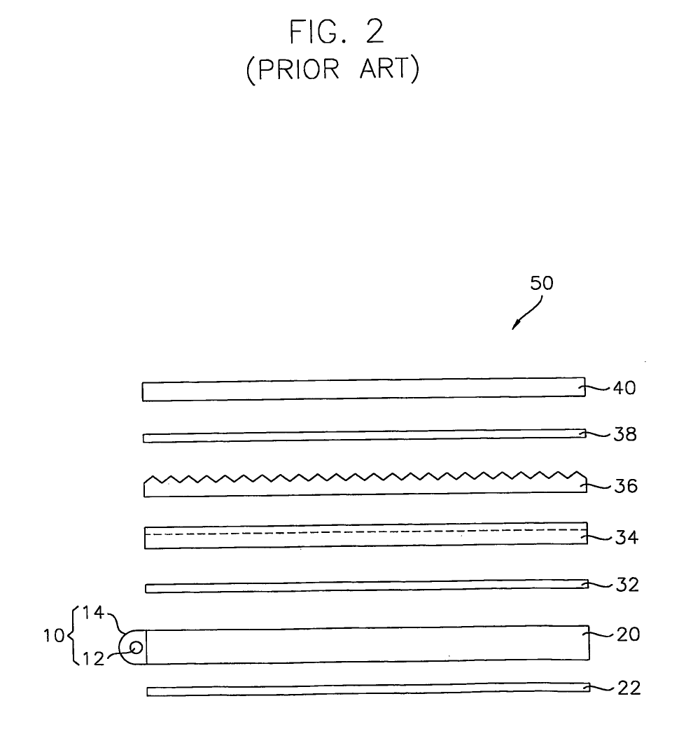

### BEST MODE FOR CARRYING OUT THE INVENTION

The present invention will now be described in detail with reference to the accompanying drawings.

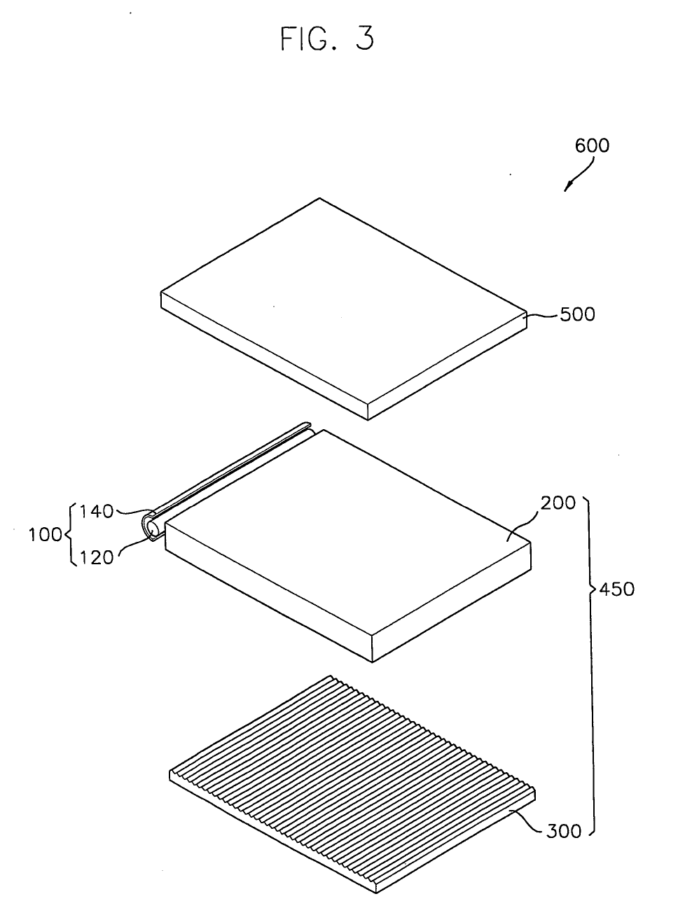

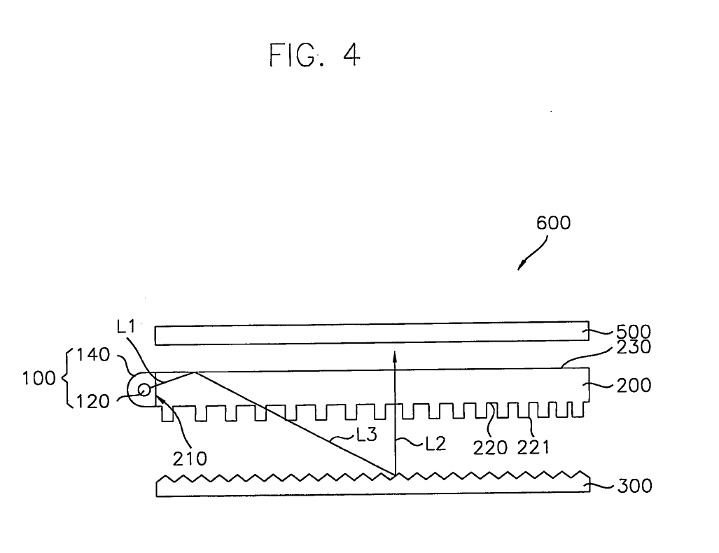

FIG. 3 is an exploded perspective view showing a liquid crystal display apparatus according to one preferred embodiment of the present invention, and FIG. 4 is a cross-sectional view showing the liquid crystal display apparatus of FIG. 3.

Referring to FIGS. 3 and 4, a liquid crystal display apparatus 600 includes a liquid crystal display panel 500 for displaying images and a backlight assembly 450 for supplying uniform lights to the liquid crystal display panel 500.

The liquid crystal display panel 500 has a TFT substrate (not shown) formed with switching elements and pixel electrodes, etc., a color filter substrate (not shown) formed with RGB pixels and common electrodes, and a liquid crystal (not shown) placed between the TFT substrate and the color filter substrate.

Because the liquid crystal display apparatus 600 is a passive light device incapable of emitting lights itself, the liquid crystal display apparatus 600 further includes a backlight assembly 450 attached to the rear surface of the liquid crystal display panel 500 in order to provide lights toward the liquid crystal display panel 500.

The backlight assembly 450 includes a light source section 100 provided with a lamp 120 for generating a first light L1 and a lamp cover 140 for covering a lateral surface of the lamp 120, and a light guiding section for supplying a second light L2 having an enhanced axial brightness toward the liquid crystal display panel 500 by changing the path of the first light L1 emitted from the light source section 100.

In more detail, the light guiding section has a light guiding plate 200 for guiding the first light L1, and a reflecting plate 300 that receives a third light L3 guided by the light guiding plate 200 so as to reflect the third light L3. The reflected light L3 is a second light L2 having an enhanced axial brightness with respect to liquid crystal display panel 500.

The lamp 120 chiefly employs a cold cathode tube, and the first light L1 is incident via the lateral surface of the light guiding plate 200, i.e., an incident plane 210 equipped with the lamp 120. A reflection member is formed on the inner surface of a lamp cover 140 to reflect the first light L1, which is generated from the lamp 120 in the radial direction, toward the incident plane 210 of the light guiding plate 200, thereby enhancing utilization efficiency of the first light L1.

The light guiding plate 200 is a flat type plate with a thickness that is uniform from one lateral side equipped with the light source section 100 to the other lateral side opposite to the one lateral side. At this time, the shape of the light guiding plate 200 is not restricted to the flat type, but it may be applied to a wedge-shaped light guiding plate. Accordingly, the thickness of the light guiding plate becomes thinner according as it is further from one lateral side provided with the light source section 100. Namely, it is the thickest at one lateral side with the light source section 100, and the thinnest at the other lateral side opposite to the one lateral side.

The light guiding plate 200 is generally made of a light and transparent polymethylmethacrylate (PMMA) group with high strength so as not to be easily broken or deformed. Accordingly, the light guiding plate 200 is made of material having a refractive index of 1.49.

The light guiding plate 200 has the incident plane 210, a first exit surface 220, and an exit surface 230. The incident plane 210 is located at the lateral surface where the light source section 100 is installed, and receives the first light L1. A first exit surface 220 faces the reflecting plate 300, guides the first light L1 toward the reflecting plate 300, and emits the third light L3. The exit surface 230 faces the liquid crystal display panel 500, and transmits the second light L2 reflected by the reflecting plate 300 toward the liquid crystal display panel 500.

The first exit surface 220 has a plurality of light guide patterns 221 for guiding the first light L1 toward the reflecting plate 300. The light guide patterns 221 will be described later with reference to the accompanying drawings.

The reflecting plate 300 is disposed on the lower portion of the light guiding plate 200. At this time, a plurality of protruding portions having a triangular prism shape are formed on the surface of the reflecting plate 300, in which the surface is opposite to the first exit surface 220 of the light guiding plate 200. Therefore, the reflecting plate 300 transforms the third light L3 guided by the light guiding plate 200 into the second light L2 having enhanced axial brightness, and reflects the second light L2 toward the liquid crystal display panel 500.

On the other hand, although it is not illustrated in the drawings, a diffusion sheet or a protective sheet may be further provided between the light guiding plate and the liquid crystal display panel.

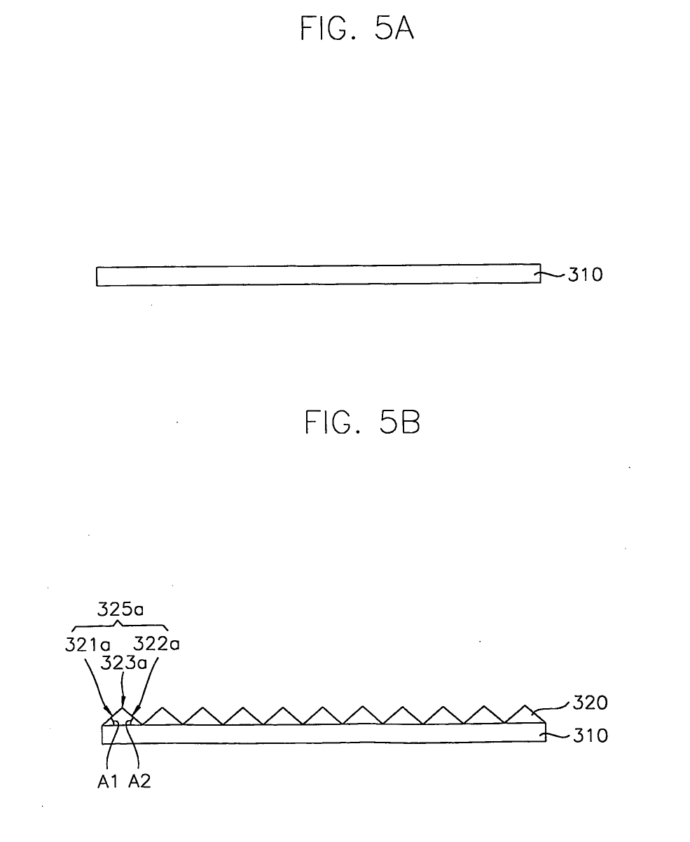

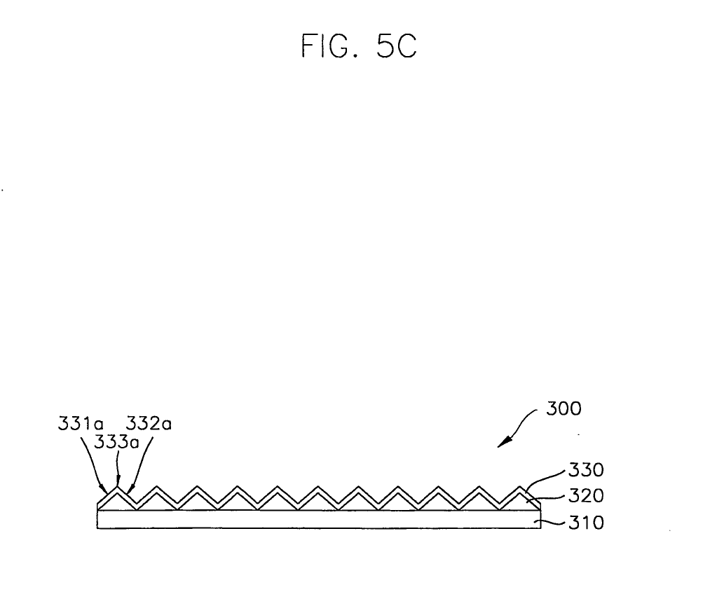

Hereinafter, referring to FIGS. 5A to 9B, the structure of the reflecting plate according to the present invention will be described in detail.

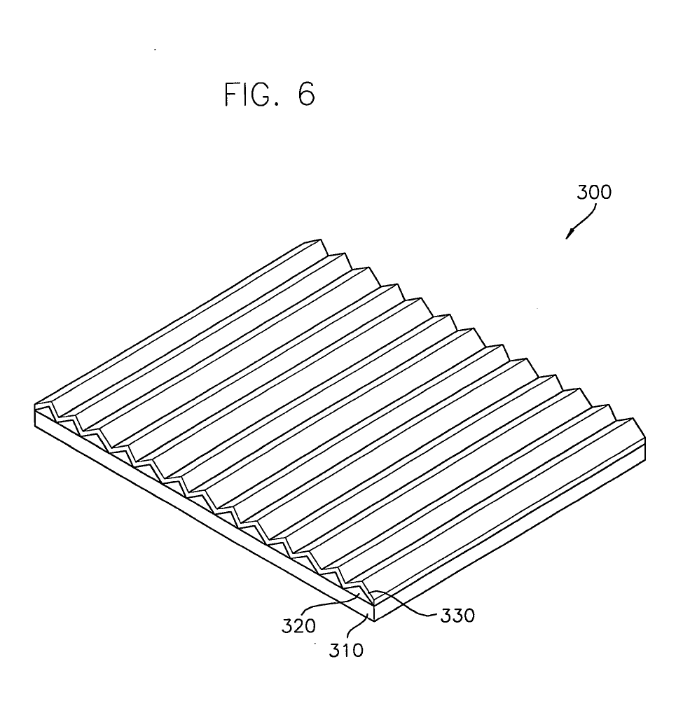

FIGS. 5A to 5C are cross-sectional views showing a manufacturing method of the reflecting plate of FIG. 4 according to a first preferred embodiment of the present invention. FIG. 6 is a perspective view showing the structure of the reflecting plate of FIG. 5C.

Referring to FIGS. 5A to 5C, the reflecting plate 300 is completed by forming a first reflecting layer 330 on a first converging layer 320 that has a plurality of first protruding portions 325a on a supporting layer 310.

When the supporting layer 310 comprised of a poly-ethyleneterephthalate (hereinafter referred to as “PET”) group is provided as shown in FIG. 5A, the first converging layer 320 comprised of an acrylic resin is coated on the supporting layer 310 as shown in FIG. 5B. The first converging layer 320 is a layer formed with a plurality of first protruding portions 325a having a triangle shape on the supporting layer 310.

Each of the first protruding portions 325a is formed by a first slanted plane 321a forming a first angle A1 with a surface of the supporting layer 310 and a second slanted plane 322a forming a second angle A2 with a surface of the supporting layer 310. A first end portion of the first slanted plane 321a and a second end portion of the second slanted plane 322a form a first pitch 323a. At this time, the first pitch 323a is a peaked shape.

It is preferable that the first and second angles A1 and A2 are between 30° and 45°. Accordingly, an angle of the first pitch 323a formed by the first slanted plane 321a and the second slanted plane 322a is between 90° and 120° that is obtained by subtracting the sum of the first and second angles A1 and A2 from the sum of the three angles of the triangle. Also, it is preferable that the first angle A1 of the plurality of the first protruding portions 325a is identical to the second angle A2 of the plurality of the first protruding portions 325a.

The reason for setting the first and second angles A1 and A2 between 30° and 45° will be described later with reference to accompanying drawings.

Referring to FIG. 5C, the first reflecting layer 330 is formed to have a uniform thickness on the first converging layer 320. At this time, the first reflecting layer 330 is comprised of aluminum oxide (Al₂O₃), which is formed on the first converging layer 320 by means of an evaporation technique. Because the first reflecting layer 330 is formed to have a uniform thickness on the first converging layer 320, it has a surface structure identical with that of the first converging layer 320. In other words, the first reflecting layer 330 has a first reflecting plane 331a forming the first angle (A1) with the supporting layer 310 and a second reflecting plane 332a forming the second angle (A2) with the supporting layer 310. At this time, a third end portion of the first reflecting plane 331a and a fourth end portion of the second reflecting plane 332a form a second pitch 333a that is a peaked shape.

As shown in FIG. 6, the plurality of the first protruding portions 325a are formed repeatedly from one end portion of the reflecting plate 300 to the other end portion opposite to the one end. At this time, each of first protruding portions 325a is formed successively parallel with one another. More specifically, the plurality of the first protruding portions 325a is extended to a longitudinal direction of a lamp so as to form parallel relation with the lamp.

Accordingly, the first light L1 generated from the lamp can be reflected on the first and second reflecting planes 331a and 332a of the first protruding portions 325a so as to be exited toward the light guiding plate 200.

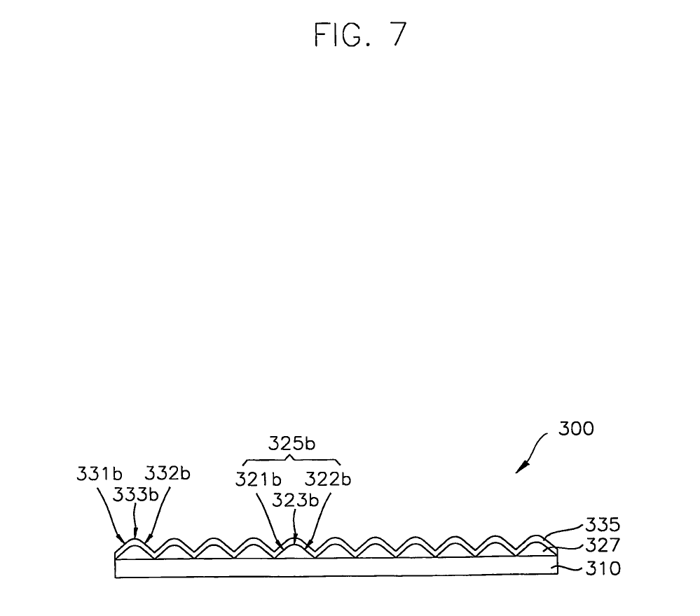

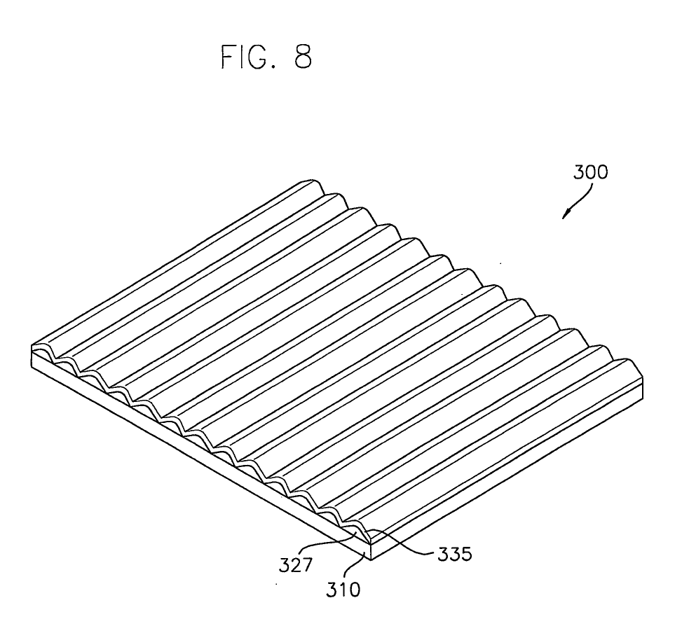

FIGS. 7 and 8 are views showing the structure of the reflecting plate according to a second preferred embodiment of the present invention.

Referring to FIG. 7, the second converging layer 327 has a plurality of second protruding portions 325b formed by the first slanted planes 321b and the second slanted planes 322b. The second protruding portions 325b have a first pitch 323b formed by joining the first and second slanted planes 321b and 322b, and the first pitch 323b has a rounded shape. At this time, the second reflecting layer 335 is provided to have uniform thickness on the second converging layer 327. Consequently, the second reflecting layer 335 is formed by the first reflecting plane 331b and the second reflecting plane 332b, and the second reflecting layer 335 has a second pitch 333b. The second pitch 333b is formed by joining the first and second reflecting planes 331b and 332b, and the second pitch 333b has a rounded shape.

As described in detail above, the second pitch 333b of the reflecting plate 300 has a rounded shape to alleviate an external impact applied to the reflecting plate 300 as compared with a second pitch 333b having a peaked shape.

As shown in FIG. 8, a plurality of the second protruding portions 327 are formed repeatedly from one end portion of the reflecting plate 300 to the other end portion opposite to the one end portion. At this time, the plurality of second protruding portions 325b is formed to be successively parallel with one another, respectively. More specifically, the plurality of the second protruding portions 325b is extended in the longitudinal direction of the lamp to be the parallel relation with the lamp.

Accordingly, the first light (L1) generated from the lamp can be reflected on the first and second reflecting planes 331b and 332b so as to be exited toward the light guiding plate 200.

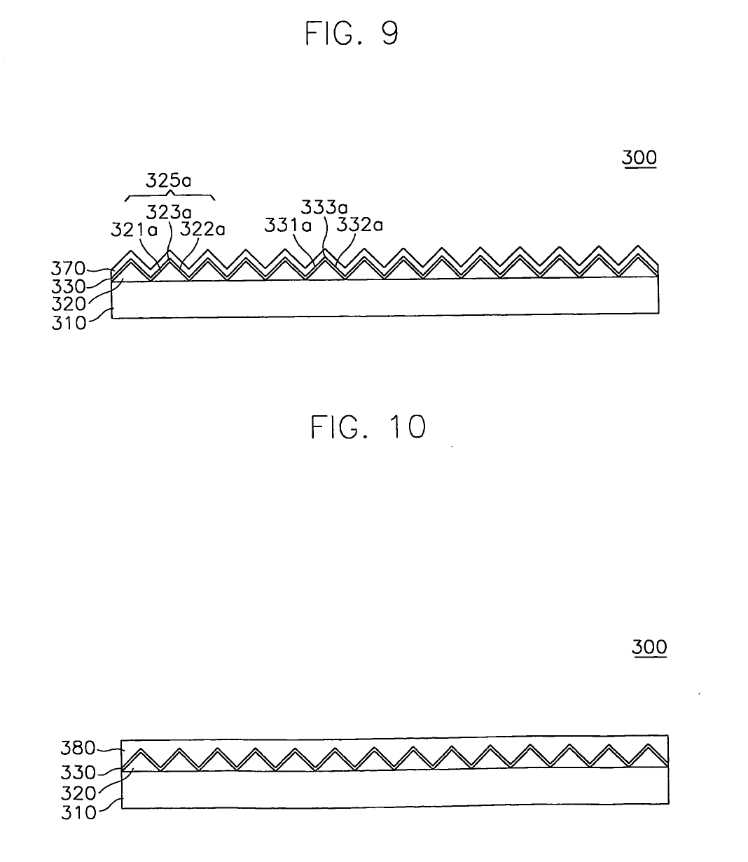

Referring to FIGS. 9 and 10, a reflecting plate 300, which has a protecting layer 370 on the reflection layer, is illustrated. Since the elements of FIGS. 9 and 10 are the same as those of FIG. 5C, the same reference numerals as in FIG. 5c are used for the elements of FIGS. 9 and 10, and any further explanation on those elements of FIGS. 9 and 10 will be omitted.

FIG. 9 shows a structure of the reflecting plate according to a third preferred embodiment of the present invention.

Referring to FIG. 9, the reflecting plate 300 includes a supporting layer 310, a converging layer 320 that has a plurality of first protruding portions 325a on a supporting layer 310, a reflecting layer 330 uniformly formed on top of the converging layer 320, and a protecting layer 370 which has a uniform thickness on the reflecting layer 330 and protects the reflecting layer 330.

The protecting layer 370 is preferably comprised of a transparent material having a low diffraction index so that the third light L3, which is reflected on the reflecting layer 330 and exited therefrom, may advance without hindrance. The protecting layer 370 protects the reflecting layer 330. Preferably, the protecting layer 370 is comprised of ITO (Indium Tin Oxide) or PET (polyethylene terephthalate).

The protecting layer 370 has the same surface profile as the reflecting layer 330 because the protecting layer 370 has a uniform thickness and is formed on the reflecting layer 330.

The reflecting layer 330 can be protected from external shocks by forming the protecting layer 370 on top of the reflecting layer 330. The protecting layer 370 may be thick enough to protect the reflecting layer 330. The thickness of the LCD increases according as the thickness of the protecting layer 370 increases. Thus, it is unpreferable that the protecting layer 370 is too thick.

FIG. 10 shows a structure of the reflecting plate 300 according to a fourth preferred embodiment of the present invention;

Referring to FIG. 10, the reflecting plate 300 includes a supporting layer 310, a converging layer 320 that has a plurality of first protruding portions 325a on a supporting layer 310, a reflecting layer 330 uniformly formed on top of the converging layer 320, and a protecting layer 380. The protecting layer 380 for protecting the reflecting layer 330 is formed on top of the reflecting layer 330, and an upper surface of the protecting layer 380 is flat.

The protecting layer 380 has the flat upper surface regardless of the structure of the reflecting layer 330, therefore the protecting layer 380 may absorb external shocks and thus may protect more safely the reflecting layer 330.

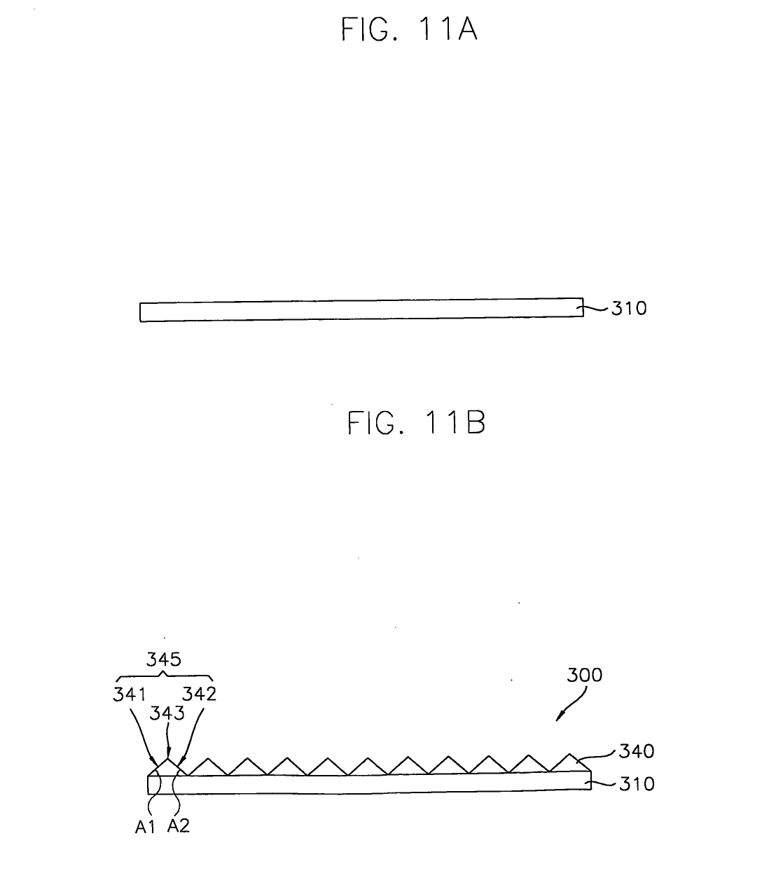

FIGS. 11A and 11B are cross-sectional views showing the method for manufacturing the reflecting plate according to a fifth preferred embodiment of the present invention.

Referring to FIGS. 11A and 11B, a third reflecting layer 340 formed with a plurality of third protruding portions 345 is formed directly on the supporting layer 310 comprised of PET. More specifically, the plurality of the third protruding portions 345 has a third reflecting plane 341 forming the first angle A1 with the surface of the supporting layer 310 and a fourth reflecting plane 342 forming the second angle A2 with the surface of the supporting layer 310. At this time, a fifth end portion of the third reflecting plane 341 and a sixth end portion of the fourth reflecting plane 342 are joined with each other to form a third pitch 343.

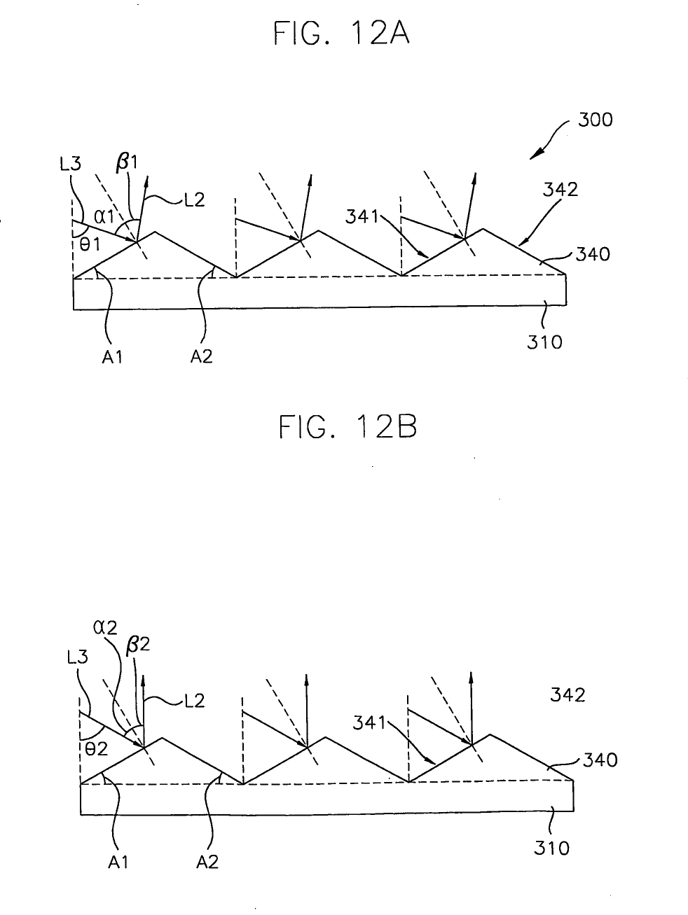

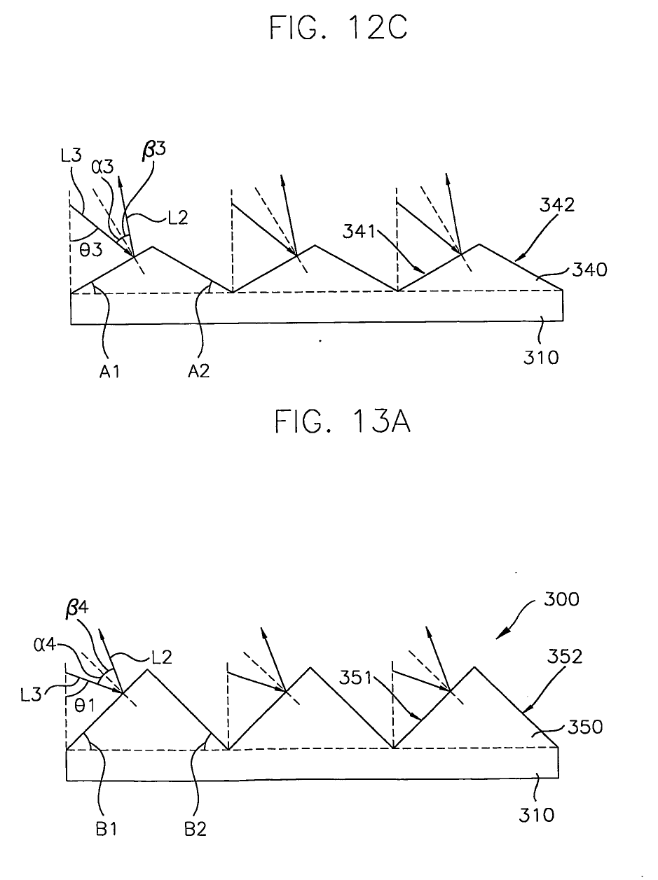

Hereinafter, referring to FIGS. 12A to 14C, the reason for setting the first and second angles A1 and A2 of the third protruding portion 345 any angle between 30° and 40° will be described in detail. Because the light guiding plate 200 is comprised of PMMA substance, the refractive index of the light guiding plate 200 is about 1.49. At this time, it is described with reference to an example in which the third light L3 exits from the light guide patterns 221 of the light guiding plate 200 at an exiting angle of 50°, 60° and 70°. The reason for taking 50°, 60° and 70° as the exiting angle of the third light L3 exiting from the light guiding plate 200 as the example will be described later with reference to accompanying drawings.

FIGS. 12A to 12C are perspective views for explaining the structure of the reflecting plate.

Here, an incident angle is defined as an angle formed by an incident light and a normal line of an incident plane, an exiting angle is defined by an angle formed by an exiting light and an extended line from one lateral surface of the supporting layer 310. Also, a reflecting angle is defined by an angle formed by a reflected light and a normal line of a reflecting plane, and a refracting angle is defined by an angle formed by an exiting light exited after being refracted and a normal line of the refracting plane. Also, minus ‘−’ used in the angle denotes the same direction with the supporting layer 310 on a basis of the normal line of the third reflecting plane 341 as a reference line, and plus ‘+’ used in the angle denotes the same direction with the liquid crystal display panel 500 on a basis of the normal line of the third reflecting plane 341 as a reference line.

As shown in FIGS. 12A to 12C, the third reflecting layer 340 is formed by the third reflecting plane 341 forming a first angle A1 with the supporting layer 310 and the fourth reflecting plane 342 forming a second angle A2 with the supporting layer 310. At this time, it is described by a example in which the third light L3 exits from the light guide pattern 221 at a first exiting angle θ1, a second exiting angle θ2 and a third exiting angle θ3.

First, referring to FIG. 12A, the third reflecting plane 341 forms the first angle A1, i.e., 30° with the supporting layer 310. The third light L3 exits from the light guide patterns 221 at the first exiting angle θ1, i.e., 70°, and is incident to the third reflecting plane 341. At this time, the third light L3 is incident at a first incident angle α1, i.e., −40° that is decided by the first angle A1 and the first exiting angle θ1. Thereafter, the third light L3 is reflected at a first reflecting angle β1, i.e., +40° identical to the first incident angle α1, and proceeds toward the liquid crystal display panel 500 as a second light L2.

Referring to FIG. 12B, the third reflecting plane 341 is sloped at the first angle A1, i.e., 30°, with respect to the supporting layer 310. The third light L3 exits from the light guide patterns 221 at the second exiting angle θ2, i.e., 60°, and is incident to the third reflecting plane 341. At this time, the third light L3 is incident at a second incident angle α2, i.e., −30° that is decided by the first angle A1 and the second exiting angle θ2. Thereafter, the third light L3 is reflected from the third reflecting plane 341 at the second reflecting angle β2, i.e., +30° identical to the second incident angle α2, and proceeds toward the liquid crystal display panel 500 as the second light L2.

Referring to FIG. 12C, the third reflecting plane 341 is slanted at the first angle A1, i.e., 30°, with respect to the supporting layer 310. The third light L3 exits from light guide patterns at the third exiting angle θ3, i.e., 50°, and is incident to the third reflecting plane 341. At this time, the third light L3 is incident at a third incident angle α3, i.e., −20° that is decided by the first angle A1 and the third exiting angle θ3. After this, the third light L3 is reflected from the third reflecting plane 341 at the third reflecting angle β3, i.e., +20° identical to the third incident angle α3, and proceeds toward the liquid crystal display panel 500 as the second light L2.

As shown in FIGS. 12A, 12B and 12C, it is most preferable that the exiting angle of the third light L3 is adjusted so as to allow the third light L3 to exit from the light guiding plate 200 at an angle of 60° when the third and fourth reflecting planes 341 and 342 of the reflecting plate 300 are sloped from the supporting layer 310 at the angle of 30°. Therefore, the second light L2 reflected on the reflecting plate 300 can proceed in the front direction with respect to the light guiding plate.

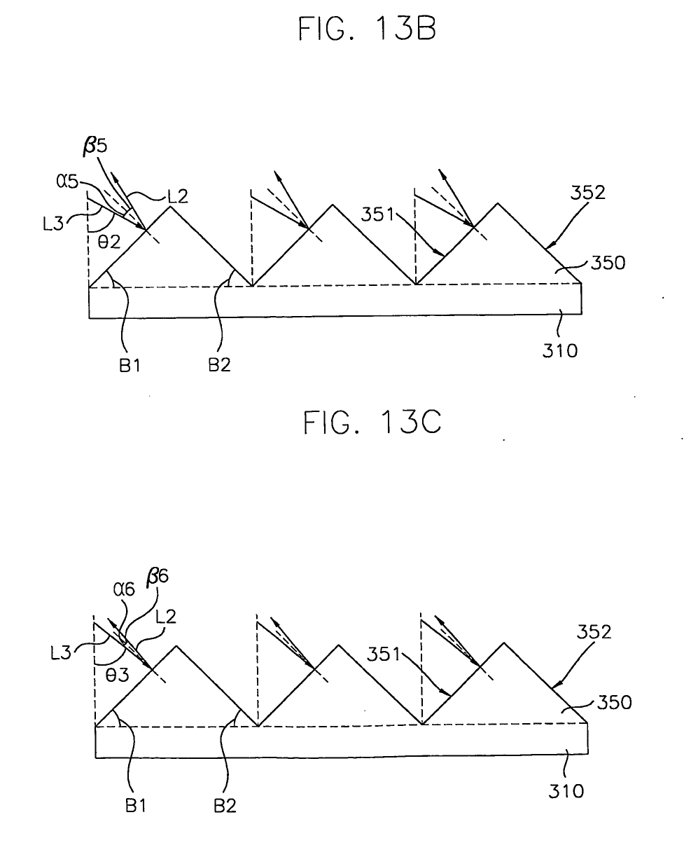

On the other hand, as shown in FIGS. 13A, 13B and 13C, the fourth reflecting layer 350 is formed by a fifth reflecting plane 351 forming at a third angle B1 with the supporting layer 310 and a sixth reflecting plane 352 forming at a fourth angle B2 with the supporting layer 310. At this time, it is described by an example in which the third light L3 exits from the light guide patterns 221 at the first exiting angle θ1, the second exiting angle θ2 and the third exiting angle θ3.

First, referring to FIG. 13A, the fifth reflecting plane 351 is inclined at the third angle B1, i.e., 45°, with respect to the supporting layer 310. The third light L3 exits from the light guide patterns 221 at the first exiting angle θ1, i.e., 70°, and is incident to the fifth reflecting plane 351. At this time, the third light L3 is incident at the fourth incident angle α4, i.e., −25° that is decided by the third angle B1 and the first exiting angle θ1. Thereafter, the third light L3 is reflected from the fifth reflecting plane 351 at a fourth reflecting angle β4, i.e., +25° identical to the fourth incident angle α4, and proceeds toward the liquid crystal display panel 500 as the second light L2.

Referring to FIG. 13B, the fifth reflecting plane 351 is sloped at the third angle B1, i.e., 45° with respect to the supporting layer 310. The third light L3 exits from the light guide patterns 221 at the second exiting angle θ2, i.e., 60°, and is incident to the fifth reflecting plane 351. At this time, the third light L3 is incident at a fifth incident angle α5, i.e., −15° that is decided by the third angle B1 and the second exiting angle θ2. Thereafter, the third light L3 is reflected from the fifth reflecting plane 351 at a fifth reflecting angle β5, i.e., +15° identical to the fifth incident angle α5, and proceeds toward the liquid crystal display panel 500 as the second light L2.

Referring to FIG. 13C, the fifth reflecting plane 351 is slanted by the third angle B1, i.e., 45° with respect to the supporting layer 310. The third light L3 exits from the light guide patterns 221 at the third exiting angle θ3, i.e., 50°, and is incident to fifth reflecting plane 351. At this time, the third light L3 is incident at the sixth incident angle α6, i.e., −5° that is decided by the third angle B1 and the third exiting angle θ3. After this, the third light L3 is reflected from the fifth reflecting plane 351 at a sixth reflecting angle β6, i.e., +5° identical to the sixth incident angle α6, and proceeds toward the liquid crystal display panel 500 as the second light L2.

As shown in FIGS. 13A, 13B and 13C, although the second light L2 has less probability of proceeding toward the front direction in comparison with being reflected by the third reflecting plane 341, most of the second light L2 proceeds in the front direction with respect to the liquid crystal display panel 500 provided with on the reflecting plate 300.

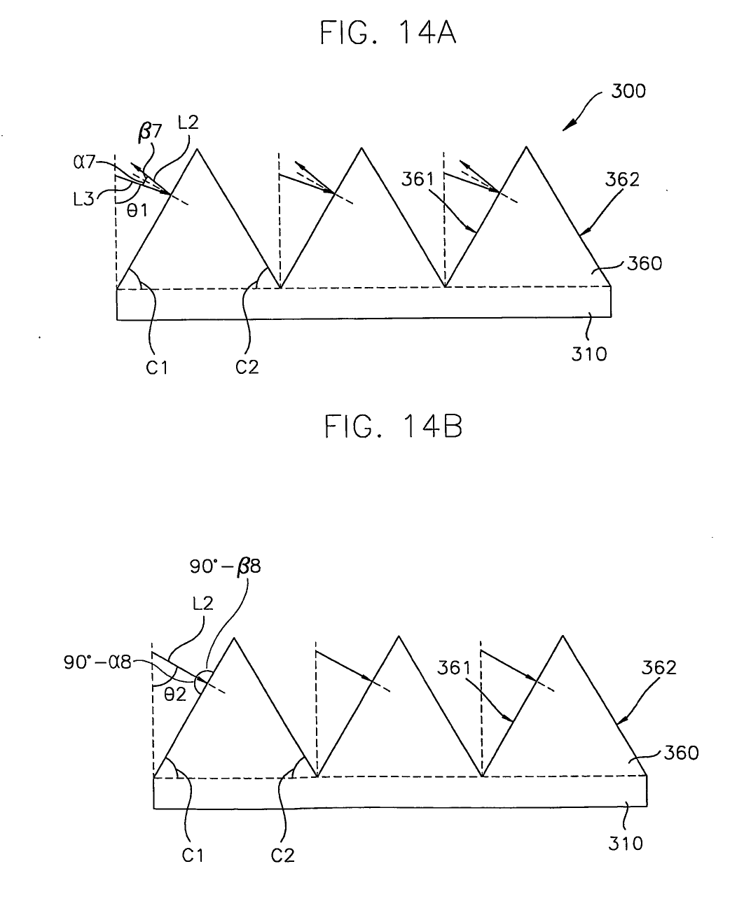

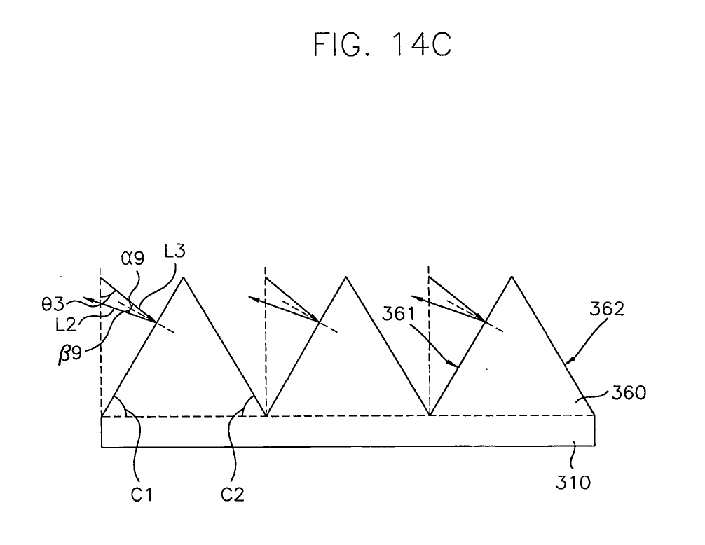

Meanwhile, as shown in FIGS. 14A, 14B and 14C, the fifth reflecting layer 360 is formed by a seventh reflecting plane 361 inclined from the supporting layer 310 at a fifth angle C1 and an eighth reflecting plane 362 inclined from the supporting layer 310 at a sixth angle C2. At this time, it is described by an example in which the third light L3 exits from the light guide patterns 221 at the first exiting angle θ1, the second exiting angle θ2 and the third exiting angle θ3.

First, referring to FIG. 14A, the seventh reflecting plane 361 is inclined at the fifth angle C1, i.e., 60° with respect to the supporting layer 310. The third light L3 exits from the light guide patterns 221 at the first exiting angle θ1, i.e., 70°, and is incident to the seventh reflecting plane 361. At this time, the third light L3 is incident at a seventh incident angle α7, i.e., −10° that is decided by the fifth angle C1 and the first exiting angle θ1. Thereafter, the third light L3 is reflected from the seventh reflecting plane 361 at a seventh reflecting angle β7, i.e., +10° identical to the seventh incident angle α7, and proceeds toward the liquid crystal display panel 500 as the second light L2.

Referring to FIG. 14B, the seventh reflecting plane 361 is sloped at the fifth angle C1, i.e., 60° with respect to the supporting layer 310. The third light L3 exits from the light guide patterns 221 at the second exiting angle θ2, i.e., 60°, and is incident to the seventh reflecting plane 361. At this time, the third light L3 is incident perpendicularly on the seventh reflecting plane 361. So the angle formed by the third light L3 and the seventh reflecting plane 316, i.e., ‘90° minus the eighth incident angle α8’ becomes 90°, and the eighth incident angle α8 becomes 0°. Accordingly, the third light L3 is reflected again at an angle β8 identical to the eighth incident angle α8.

Referring to FIG. 14C, the seventh reflecting plane 361 is slanted at the fifth angle C1, i.e., 60° with respect to the supporting layer 310. The third light L3 exits from the light guide patterns 221 at the third exiting angle θ3, i.e., 50°, and is incident to seventh reflecting plane 361. At this time, the third light L3 is incident at a ninth incident angle α9, i.e., +10° that is decided by the fifth angle C1 and the third exiting angle θ3. After this, the third light L3 is reflected from the seventh reflecting plane 361 at the ninth reflecting angle β9, i.e., −10° identical to the ninth incident angle α9 to be the second light L2.

As shown in FIGS. 14A, 14B and 14C, most of the second light L2 do not proceed in the front direction with respect to the liquid crystal display panel 500 provided with on the reflecting plate 300.

As described with reference to FIGS. 12A to 14C, when the angle formed by the supporting layer 310 and the reflecting plane 300 is 30° or 40°, most of the second light L2 proceeds in the front direction with respect to the liquid crystal display panel 500. Therefore, it is preferable that the angle formed by the supporting layer 310 and the reflecting plane 300 is within the range of 30° to 45°.

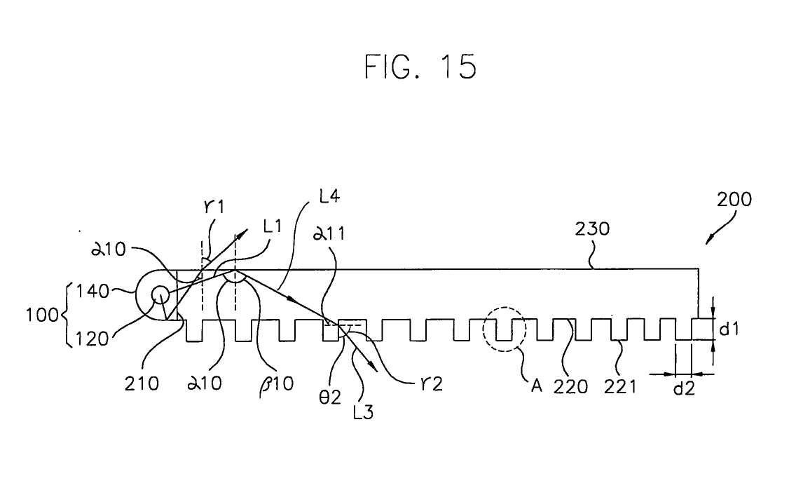

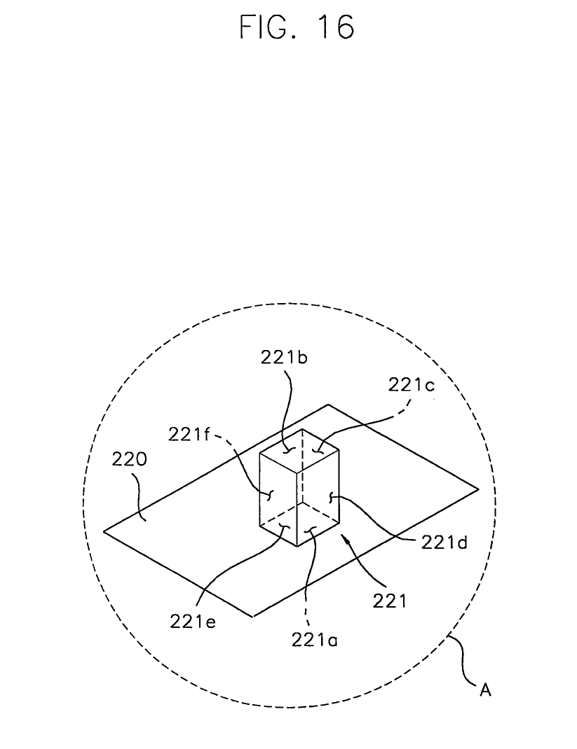

FIG. 15 is a cross-sectional view showing a light guiding plate of FIG. 3, and FIG. 16 is an enlarged view of a portion A designated in FIG. 15.

Referring to FIG. 15, the light guiding plate 200 includes an incident plane 210, a first exit surface 220, and the exit surface 230.

The incident plane 210 is disposed at the light source section 100, and receives the first light L1. The first exit surface 220 faces oppositely to the first reflection layer 330 of the reflection plate 300 guides the first light L1 toward the reflecting plate 300 to exit the third light L3. The exit surface 230 is placed oppose to the first exit surface 220, and transmits the second light L2 reflected on the reflecting plate 300 therethrough.

The first exit surface 220 has a light guide patterns 221 protruding toward the reflecting plate 300 for guiding the first light L1 toward the reflecting plate 300. The light guide pattern 221 is formed on the first exit surface 220 in a dot shape. At this time, the light guide patterns 221 are integrally formed on the light guiding plate 200 in a body. That is, the light guide patterns 221 are formed by an injected molding technique when forming the light guiding plate 200.

As shown in FIG. 16, light guide pattern 221 is hexahedral shape, and have a first surface 221a in contact with the first exit surface 220, a second surface 221b opposite to the first surface 221a, and four side surfaces, i.e., the first to fourth side surfaces, 221c, 221d, 221e and 221f adjacent to the first surface 221a and the second surface 221b.

Here, the light guide pattern 221 is formed as a regular hexahedron shape in which the first surface 221a, the second surface 221b and the first to fourth side surfaces 221c, 221d, 221e and 221f are the same altogether. Also, the light guide patterns 221 may be formed as a hexahedron shape in which a distance d1 between the first surface 221a and the second surface 221b is longer than a distance d2 between side surfaces facing each other among the four side surfaces 221c, 221d, 221e and 221f. That is, when the distance d1 is formed to be longer than the distance d2 by 1.4 times, the probability that the second light L2 is guided toward the reflecting plate 300 increases.

At this time, the distance d2 between side surfaces facing each other among the four side surfaces 221c, 221d, 221e and 221f is maintained constant from the first surface 221a to the second surface 221b.

As described above, the axial brightness is enhanced by the reflecting plate 300, and the change of the optical characteristics of the second light L2, which is incident via the first exit surface 220 of the light guiding plate 200, is prevented by integrally forming the light guide patterns 221 on the light guiding plate 200 and by maintaining the distance d2 constant. In other words, By doing that, it can minimize the phenomenon that the second light L2 proceeding in the front direction with respect to the liquid crystal display panel 300 is refracted by the light guide patterns 221 so that the second light L2 does not proceed in the front direction.

Here, the optical characteristics of a light guiding plate 200 will be described for assisting the understanding of the present invention.

As shown in FIG. 15, since the light guiding plate 200 is comprised of the substance of PMMA group, it has the refractive index of 1.49. A critical angle of the light guiding plate 200 is approximately 42.156°.

The first light L1 incident via the incident plane 210 of the light guiding plate 200 proceeds toward the exit surface 230 of the light guiding plate 200, and is incident to the exit surface 230. At this time, the first light L1 is reflected when the angle (hereinafter referred to as a tenth incident angle α10) formed by the first light L1 and the normal line of the exit surface 230 is larger than the critical angle. The first light L1 is refracted at a predetermined angle so as to exit when the tenth incident angle α10 is smaller than the critical angle.

First, when the first light L1 transmits through the exit surface 230, the first light L1 is refracted at a first refracting angle γ1 larger than the tenth incident angle α10 on the exit surface 230 because the refractive index of the light guiding plate 200 is larger than that of air.

Meanwhile, when the first light L1 is reflected on the exit surface 230, the first light L1 is reflected on the exit surface 230 to be the fourth light L4. The fourth light L4 proceeds toward the first exit surface 220 of the light guiding plate 200. Here, the first light L1 is reflected at a tenth reflecting angle β10 identical to the tenth incident angle α10. Next, the fourth light L4 proceeds toward the first exit surface 220, and is incident to the second side surface 221d of the light guide patterns 221. At this time, because an angle (hereinafter referred to as an eleventh angle α11) formed by the fourth light L4 and the normal line of the second side surface 221d is smaller than the critical angle of the light guiding plate 200, the fourth light L4 is refracted to transmit through the second side surface 221d.

Namely, since the light guide patterns 221 are comprised of the material identical to the material constituting the light guiding plate 200, the refractive index of the light guide pattern 221 is 1.49, and the critical angle is 42.156° identical to that of the light guiding plate 200. Here, because the incident angle of the fourth light L4 is smaller than the critical angle, the fourth light L4 is refracted to transmit through the second side surface 221d, and the fourth light L4 exits toward a reflecting plate 330 at a second refracting angle γ2 larger than the eleventh incident angle α11 to.

Here, the second refracting angle γ2 is defined by the following equation 1:

N*SIN α11=SIN γ2 (1)

Wherein the reference symbol N denotes the refractive index of the light guide plate 200, α11 denotes the eleventh incident angle, and γ2 denotes the second refracting angle.

As described above, the eleventh angle α11 should be smaller than the critical angle of the light guiding plate 200 in order that the third light L3 is refracted to exit from the light guiding plate 200 toward the reflecting plate 300. For this reason, the eleventh incident angle α11 is between 0° and 42.156°. Accordingly, the second refracting angle γ2 has the range of approximately 0° to 47.844° according to the above equation 1. That is, the third light L3 has the second exiting angle θ2 between approximately 42.156° and 90°.

Because the third light L3 exits at an angle between 42.156° and 90° from the light guiding plate 200, the reflecting plate 300 has the first and second reflecting planes 331 and 332 inclined at an angle within a range of 30° to 45° with regard to the supporting layer 310. For example, when the third light L3 exits at the angle of 60° from the light guiding plate 200, the first and second reflecting planes 331 and 332 are formed to be sloped at the angle of 30° with regard to the supporting layer 310. Otherwise, when the third light L3 exits at the angle of 90° from the light guiding plate 200, the first and second reflecting planes 331 and 332 are formed to be sloped at the angle of 45° with regard to the supporting layer 310.

Consequently, the reflecting plate 300 reflects the third light L3, and allows the second light L2 to exit from the reflecting plate 300 in the front direction with respect to the light guiding plate 200.

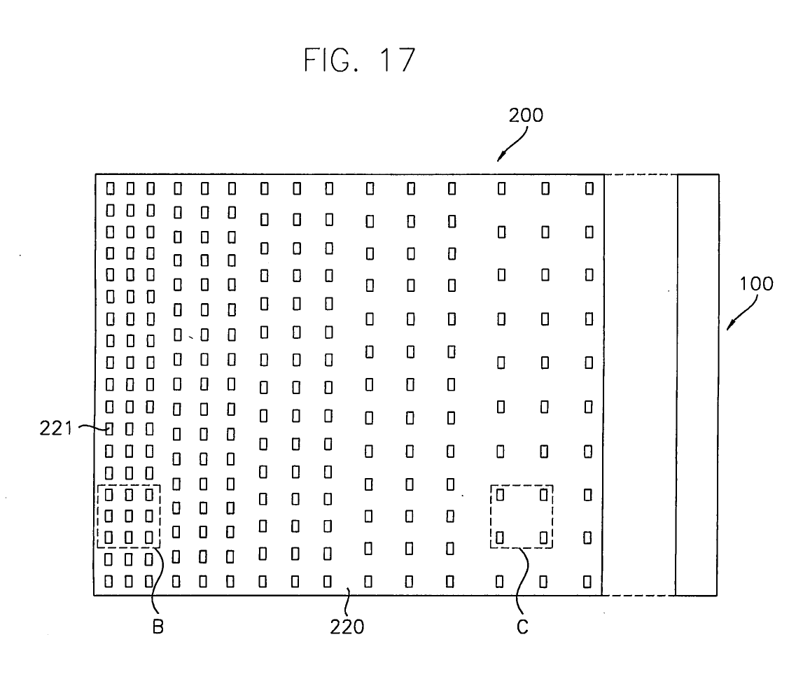

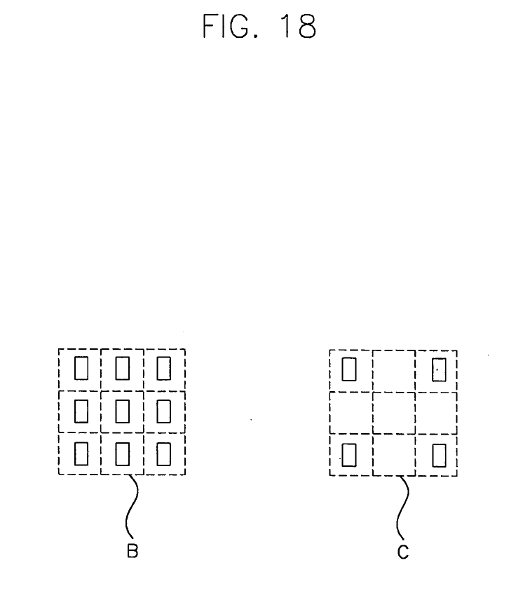

FIG. 17 is a plane view showing the rear plane of the light guiding plate of FIG. 15, and FIG. 18 is an enlarged view showing partly enlarged B and C portions of FIG. 17.

Referring to FIGS. 17 and 18, the first exit surface 220 of the light guiding plate 200 is formed with a plurality of light guide patterns 221. The intervals between the light guide patterns 221 become narrower according as being farther from the light source section 100. When comparing an enlarged C region adjacent to the light source section 100 with an enlarged B region, which is opposite to the C region and has the same area as the C region, C region is formed with four light guide patterns 221 and B region is formed with nine light guide patterns 221. In other words, as being further from the light source section 100, the number of light guide patterns 221 per unit area increases to increase the density of light guide patterns 221.

The reason for forming the light guide patterns 221 will be explained below in detail.

Generally, since a light source section 100 is placed beside one side surface of a light guiding plate 200, the luminance is high at one side surface equipped with the light source section 100 and the luminance is low relatively at the other side surface opposite to the one side surface. In other words, as being further from the light source section 100, the luminance becomes relatively lower. In order to compensate for the difference of the luminance, the light guide patterns 221 are formed more closely as being further from the light source section 100.

Accordingly, the quantity of the light proceeding toward the reflecting plate 300 in the C region adjacent to the light source section 100 is approximately the same as the quantity of the light proceeding toward the reflecting plate 300 in the B region further from the light source section 100 compared with the C region.

Although not shown in the drawing, when each light source sections are placed at both one side surface of the light guiding plate and the other side surface opposite to the one side surface, the intervals between the light guide patterns are narrower as being further from the one side surface and the other side surface. Namely, the density of the light guide patterns is the highest at the middle portion of the light guiding plate. Thus, the difference between the luminance at the one side surface and the other side surface equipped with the light source section and the luminance at the middle portion can be compensated.

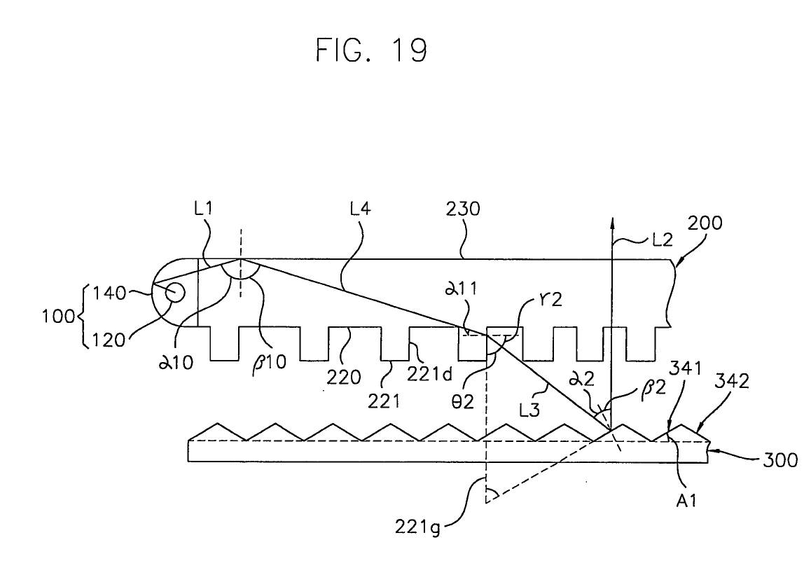

FIG. 19 is a perspective view showing the optical path in a backlight assembly according to one preferred embodiment of the present invention. Here, it is described by an example in which the tenth incident angle α10 is 70° when the first light L1 from the light source section 100 is incident to the exit surface 230 of the light guiding plate 200 at the tenth incident angle α10.

Referring to FIG. 19, the first light L1 from the light source section 100 proceeds toward the exit surface 230 side of the light guiding plate 200, and is incident to the exit surface 230. The first light L1 is incident to the exit surface 230 at the tenth incident angle α10, i.e., 70°. At this time, since the tenth incident angle α10 is larger than the critical angle, i.e., 42.156° of the light guiding plate 200, the first light L1 is reflected toward the first exit surface 220 at a tenth reflection angle β10 identical to the tenth incident angle α10.

The fourth light L4 reflected on the exit surface 230 proceeds toward the first exit surface 220, and is incident to the second side surface 221d of the light guide pattern 221 at the eleventh incident angle all. The third light L3 is incident to the second side surface 221d. At this time, since the second side surface 221d is perpendicular to the exit surface 230, the eleventh incident angle α11 is 20°. Since the eleventh incident angle α11 is smaller than the critical angle, i.e., 42.156° of the light guiding plate 200, the third light L3 exits toward the reflecting plate 300 at the second refracting angle γ2 larger than the eleventh incident angle α11 of the second light L2 with regard to the normal line of the second side surface 221d as the reference line. At this time, the second refracting angle γ2 is approximately 30° according to the above equation 1.

Consequently, the third light L3 exits from the second side surface 221d at the second exiting angle θ2, i.e., approximately 60°. After this, the third light L3 proceeds toward the reflecting plate 300, and is incident to the third reflecting plane 341 of the reflecting plate 300. Here, since the third reflecting plane 341 is sloped at the first angle A1, i.e., 30° with the supporting layer 310, the third reflecting plane 341 forms an angle of 60° with an extending line 221g of the second side surface 221d. Accordingly, when the third light L3 is incident to the third reflecting plane 341, the second incident angle α2 becomes 30°. Namely, the third light L3 forms an angle of −30° with the normal line of the third reflecting plane 341.

At this time, the third light L3 is reflected from the third reflecting plane 341 at the second reflection angle β2, i.e., +30° identical to the second incident angle α2, and the second light L2 exits so as to proceed in the front direction with respect to the exit surface 230 of the light guiding plate 200. Therefore, the liquid crystal display panel 500 displays images by means of the second light L2 with the enhanced axial brightness.

While the present invention has been particularly shown and described with reference to a particular embodiment thereof, it will be understood by those skilled in the art that various changes in form and details may be effected therein without departing from the spirit and scope of the invention as defined by the appended claims.

1. A liquid crystal display apparatus, comprising:
a light source for generating a first light;
a light guiding plate including an incident plane for receiving the first light, a first exit surface for guiding the first light transmitted through the incident plane so as to output a third light, and a second exit surface, being opposite to the first exit surface, for outputting a second light incident via the first exit surface;
a reflecting plate, being placed below a lower side of the first exit surface of the light guiding plate and having a plurality of protruding portions protruded from a reflecting plane which is opposite to the first exit surface, for reflecting the third light and providing the second light having an enhanced axial brightness to the light guiding plate; and
a liquid crystal display panel for receiving the second light from the light guiding plate to display images.

2. A liquid crystal display apparatus as claimed in claim 1, wherein the reflecting plate comprises:
a supporting layer;
a converging layer having a plurality of protruding portions, each of the protruding portions being protruded from a surface of the supporting layer so as to have a prism shape, and the protruding portions being formed repeatedly on the surface of the supporting layer from a first end portion of the supporting layer to a second end portion of the supporting layer, the second end portion being oppose to the first end portion; and
a reflecting layer covering a whole surface of the converging layer and being formed so as to have a predetermined thickness consistent on the converging layer.

3. A liquid crystal display apparatus as claimed in claim 2, wherein each of the protruding portions comprises:
a first slanted plane inclined at a first angle with the surface of the supporting layer; and
a second slanted plane inclined at a second angle with the surface of the supporting layer,
and wherein each plurality of the protruding portions has a pitch formed by the first slanted plane and the second slanted plane.

4. A liquid crystal display apparatus as claimed in claim 3, wherein the first and second angles are respectively 30° to 45°.

5. A liquid crystal display apparatus as claimed in claim 4, wherein the first angle is the same with the second angle.

6. A liquid crystal display apparatus as claimed in claim 3, wherein the pitch has a round shape.

7. A liquid crystal display apparatus as claimed in claim 3, wherein the reflecting plate further comprises a protecting layer which is formed on the reflecting layer and protects the reflecting layer.

8. A liquid crystal display apparatus as claimed in claim 4, wherein the protecting layer has a uniform thickness.

9. A liquid crystal display apparatus as claimed in claim 3, wherein an upper surface of the protecting layer is flat.

10. A liquid crystal display apparatus as claimed in claim 1, wherein the reflecting plate comprises:
a supporting layer;
a reflecting layer including having the protruding portions, each of the protruding portions being protruded from a surface of the supporting layer so as to have a prism shape, and the protruding portions being formed repeatedly on the surface of the supporting layer from a first end portion of the supporting layer to a second end portion of the supporting layer, the second end portion being opposite to the first end portion.

11. A liquid crystal display apparatus as claimed in claim 1, wherein the first exit surface comprises a plurality of light guide patterns, protruding toward the reflecting plate in a dot shape having a predetermined height, for guiding the first light toward the reflecting plate side.

12. A liquid crystal display apparatus as claimed in claim 11, wherein each plurality of the light guide patterns has a bar shape.

13. A liquid crystal display apparatus as claimed in claim 12, wherein each plurality of the light guide patterns has a square shape when viewed from the reflecting plate side.

14. A liquid crystal display apparatus as claimed in claim 13, wherein a length of a portion, which protrudes from the first exit surface, of the light guiding plate of each of the light guide patterns, is longer than a width of each of the light guide patterns.

15. A liquid crystal display apparatus as claimed in claim 14, wherein the length of each of the light guide patterns is about 1.4 times of the width of each of the light guide patterns.

16. A liquid crystal display apparatus as claimed in claim 11, wherein the light guide patterns have narrower intervals as being placed further from the light source.

17. A liquid crystal display apparatus as claimed in claim 11, wherein the light guide patterns are integrally formed on the light guiding plate.

18. A liquid crystal display apparatus comprising:
a light source for generating a first light;
a light guiding plate including an incident plane for receiving the first light, a first exit surface having a plurality of light guide patterns for guiding the first light transmitted through the incident plane so as to output a third light, and a second exit surface, being opposite to the first exit surface, for outputting a second light incident via the first exit surface;
a reflecting plate, being placed below a lower side of the first exit surface of the light guiding plate and having a plurality of protruding portions protruded from a reflecting plane which is opposite to the first exit surface, for reflecting the third light and providing the second light having an enhanced axial brightness to the light guiding plate; and
a liquid crystal display panel for receiving the second light from the light guiding plate to display images.

19. A liquid crystal display apparatus as claimed in claim 18, wherein the light guide patterns protrude toward the reflecting plate in a dot shape having a predetermined height, for guiding the first light toward the reflecting plate side.

20. A liquid crystal display apparatus as claimed in claim 19, wherein each plurality of the light guide patterns has a bar shape.

21. A liquid crystal display apparatus as claimed in claim 18, wherein the reflecting plate comprises:
a supporting layer;
a converging layer having the plurality of protruding portions, each of the protruding portions being protruded from a surface of the supporting layer so as to be a prism shape, and the protruding portion being formed repeatedly on the surface of the supporting layer from a first end portion of the supporting layer to a second end portion of the supporting layer, the second end portion being oppose to the first end portion; and
a reflecting layer covering a whole surface of the converging layer and being formed so as to have a predetermined thickness consistent on the converging layer.

22. A liquid crystal display apparatus as claimed in claim 21, wherein the plurality of protruding portions comprises:
a first slanted plane inclined at a first angle with the surface of the supporting layer; and
a second slanted plane inclined at a second angle with the surface of the supporting layer,
and wherein each plurality of the protruding portions has a pitch formed by the first slanted plane and the second slanted plane.
